(19) United States
(12) Patent Application Publication
(10) Pub. No.: US 2021/0404158 A1
(43) Pub. Date: Dec. 30, 2021

(54) SEQUENCE CONTROLLER FOR EXTRACTION POINTS

(71) Applicant: OBLAMATIK AG, Chur (CH)

(72) Inventor: ROLAND OBRIST, Scharans (CH)

(73) Assignee: OBLAMATIK AG, Chur (CH)

(21) Appl. No.: 17/292,978

(22) PCT Filed: Nov. 16, 2018
(86) PCT No.: PCT/EP2018/081531

§ 371 Date: May 11, 2021

(51) Int. Cl. E03C 1/05; G05B 19/05

(52) U.S. Cl. CPC E03C 1/055; G05B 19/056

(57) ABSTRACT

A programmable sequence controller for extraction points and peripheral devices for controlling sequences having individual sequence steps having open-loop-controlled and/or closed-loop-controlled dispensing of liquid media, the controller having a control unit for data processing and for storing and executing selectable sequence programs, having a display and a possibility for sequence program selection and a control panel for inputs, as well as interfaces for sensors and interfaces for actuating control members connectable to the control unit. To configure and edit the selectable sequence programs, the sequence controller has a modular programming surface with module boxes for the individual sequence steps, into which settings and criteria for the extraction point in question and peripheral devices associated therewith as desired properties of the liquid medium that is to be dispensed or breaks in the dispensing procedure can be input for each sequence step in a corresponding module box via the control panel.

The present invention relates to a sequence controller for extraction points. A sequence controller is to be understood as a control device or control system that controls sequential operations on devices. In the present invention, devices are meant to be extraction points and related peripheral devices. Extraction points in the context of the present invention are understood to mean devices that dispense liquid media, be they outlet fittings such as faucets, or showers, or a bathtub water inlet, or liquid dispensers for various liquids such as liquid soap, disinfectants, and personal care products.

In the case of extraction points, it has become desirable for users that instead of purely manual operation, the processes are increasingly controlled by a control system and the user is thereby preferably guided by means of a display, in particular if a sequence comprises several steps in succession and a certain sequence and duration of the steps is to be observed. Such a control system serves to improve operating convenience, helps to save water and/or energy, and is also useful for complying with hygiene regulations.

Using the example of a hand washing device, a control installation is described in EP 0 025 785 B1, which controls the sequence of steps: Water delivery for moistening the hands, soap delivery, pause time for rubbing the hands, water for rinsing and hot air from the hand dryer. The sequence is stored as a program.

EP 0 679 770 A2 describes a method for operating an outlet fitting that enables better adaptation to a user's individual needs, in that the user can first select a specific sequence program desired by him from among several sequence programs stored in a control unit, which is then displayed and started.

A control device for controlling water consumption during showering is described in DE 10 2004 052 793 B4. Individual adaptability is supported in that the control device is designed to be programmable. In addition, a display designed as an LCD display is proposed. Individual changes of the sequence program are possible on the one hand with the start button (additional shower time or interruptions), or with programming buttons. An input via an optional control panel would be made with codes.

The known prior art sequence controllers for extraction points or the sequence programs are not very flexible. At most, simple changes to the sequence are possible for the user. Changes to a sequence program or the creation of a new sequence program have so far required a specialist with knowledge of the programming language and the program codes.

It is the object of the present invention to provide an alternative sequence controller for extraction points whose sequence programs are easy to configure and edit.

This object is solved by a programmable sequence controller for extraction points having the features of claim 1. A sequence can also be referred to synonymously as a scene.

The invention further comprises a method for configuring such a sequence controller, and uses of the programmable sequence controller according to the invention at extraction points.

Preferred embodiments and variants according to the invention are shown in the respective dependent claims.

A programmable sequence controller for extraction points and peripheral devices associated therewith for controlling sequences having individual sequence steps comprising open-loop-controlled and/or closed-loop-controlled dispensing of liquid media comprises a control unit for data processing and for storing and executing selectable sequence programs, having a display and a sequence program selection option and a control panel for inputs, as well as interfaces for sensors and interfaces for actuating control members which can be connected to the control unit, and is characterized in that that the sequence controller for configuring and editing the selectable sequence programs comprises a modular programming interface with module boxes for the individual sequence steps, in which settings and criteria for the relevant extraction point and peripheral devices associated therewith, as well as desired properties of the liquid medium to be dispensed or pauses in the dispensing procedure for each sequence step, can be entered in a corresponding module box via the control panel, and the sequence steps can be lined up in the form of the corresponding module boxes to form a sequence program for the sequence.

In a programmable sequence controller according to the invention, the extraction points are preferably water extraction points.

In the programmable sequence controller according to the invention, the sequence program selection option for selecting the desired sequence program from the available stored sequence programs is preferably either represented by selectable buttons on the control panel, or it is embodied by a rotatable selector switch with a start function, or it comprises an acoustic selection option. The latter option would include a microphone and voice recognition software with voice control. In the case of impaired vision, or if nothing is to be touched for hygienic reasons, for example, the persons concerned could thus use their voice to transmit the desired choice to the sequence controller.

The display of the programmable sequence controller according to the invention is preferably designed to first indicate titles of selectable sequence programs visually and/or acoustically, and after the start of a selected sequence program to indicate the respective sequence step with the corresponding title visually and/or acoustically. By displaying the title of the respective sequence step, the user knows at all times the location within the sequence. An acoustic indication (via loudspeaker) can comprise the spoken title of the respective sequence step, and optionally be accompanied e.g. by background music.

In the programmable sequence controller according to the invention, the control panel for inputs and for configuring and editing the selectable sequence programs is preferably a screen with touch input. Such a screen, when mounted on a wall adjacent to the extraction point, can serve simultaneously as a visual display and as a sequence program selector, if the latter is represented by selectable buttons on the control panel. However, the display (optical and/or acoustic), the sequence program selection option and the control panel can also be designed as separate components.

In one embodiment of the programmable sequence controller according to the invention, the sensors that can be connected to interfaces of the control unit are pressure sensors, temperature sensors or flow sensors in supply lines, or proximity sensors. A temperature sensor can be part of a control loop to control the liquid medium to be dispensed to a set temperature specified in a module box, or to heat it to a specified temperature. A flow sensor can be used to control to a desired flow rate, or to close a valve in a supply line after a specified total flowed medium quantity (e.g., in liters) is reached. A proximity sensor can be used, among other things, to trigger a sequence or scene without contact when a user approaches.

In the programmable sequence controller according to the invention, the control members that can be connected to interfaces of the control unit for actuation are in particular control members of valves or switches of pumps in supply lines, or switches of peripheral devices. A peripheral device is, for example, an electromechanically operated bathtub plug, or a soap dispenser next to a water fitting, or a hot-air hand dryer.

The valves that can be actuated via control members are in particular shut-off valves, control valves, flow control valves or mixing valves, with mixing valves preferably being controllable to a set temperature of the liquid medium specified in a module box.

The present invention also comprises a method for configuring a programmable sequence controller according to the invention, which is characterized in that, when configuring a sequence program in the modular programming interface, as many module boxes are created one after the other from a template, defined with parameters and lined up as sequence steps are required which are subdivided in time or according to other criteria to represent a complete sequence. A template is a neutral module box for parameterization. This can be detailed differently for different types of scenes. Each created module box corresponds to a step in the subdivided sequence, wherein the criteria for subdivision are either a defined time duration of a step (e.g. the duration of a water delivery or a pause duration without water delivery), or the achievement of a certain physical property value of the medium to be delivered, e.g. a temperature achievement in a heating step or the achievement of a certain delivered medium quantity (in volume units).

In one variant, the method is characterized in that the template for the individual module boxes comprises a header and a parameter field, and a title for the respective sequence step is entered into the header of the individual module boxes created, and the parameters required for defining and controlling the respective sequence step are selected and specified in the parameter field.

The present invention further relates to the use of a programmable sequence controller according to the invention for controlling sequences or scenes with successive sequence steps at extraction points, preferably for water extraction points and related operations in their environment. Related operations may not only involve peripheral equipment, but may also include cues on the visual and/or audible display to the user to perform certain actions during the sequence steps, for example, prompts such as “wet your hands,” “soap up,” and “rinse off.” In use, the sequences or scenes are preferably selected from the group consisting of tooth brushing, showering, bathing, hand washing and hand hygiene procedures.

The latter is a focal application of the present invention, especially for hospitals or medical practices. All hygiene procedures (e.g., for cleaning and disinfecting hands before surgery) can be individually mapped and easily configured with the present invention. Guiding a user through a hand hygiene procedure by means of the sequence controller according to the invention is a great help in complying with hygiene regulations. Other advantageous aspects relate to the areas of comfort and wellness, saving water and energy, and the touch-free (acoustic) selection of a sequence program.

In the following, the invention will be explained in more detail by means of schematic figures showing examples of possible sequences or scenes in a modular programming interface of the sequence controller according to the invention, without limiting the scope of the present invention, wherein:

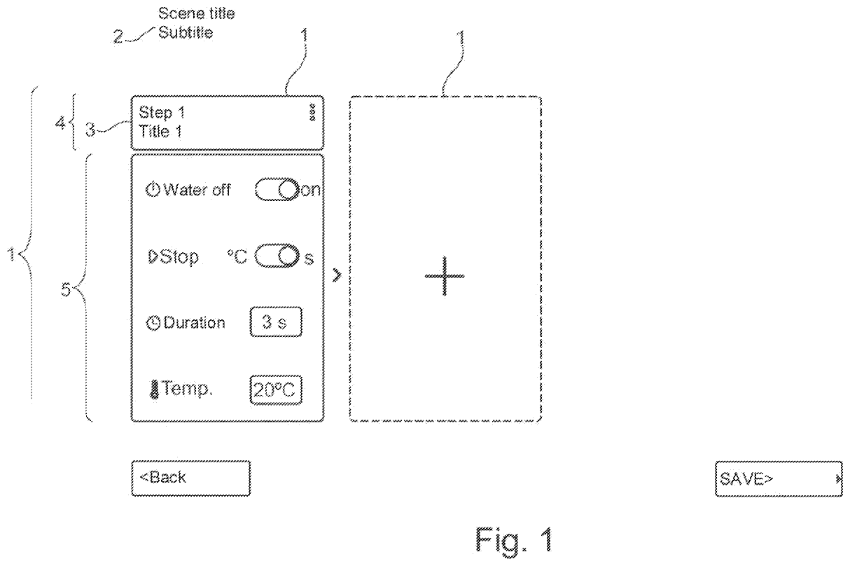

FIG. 1 shows a neutral scene

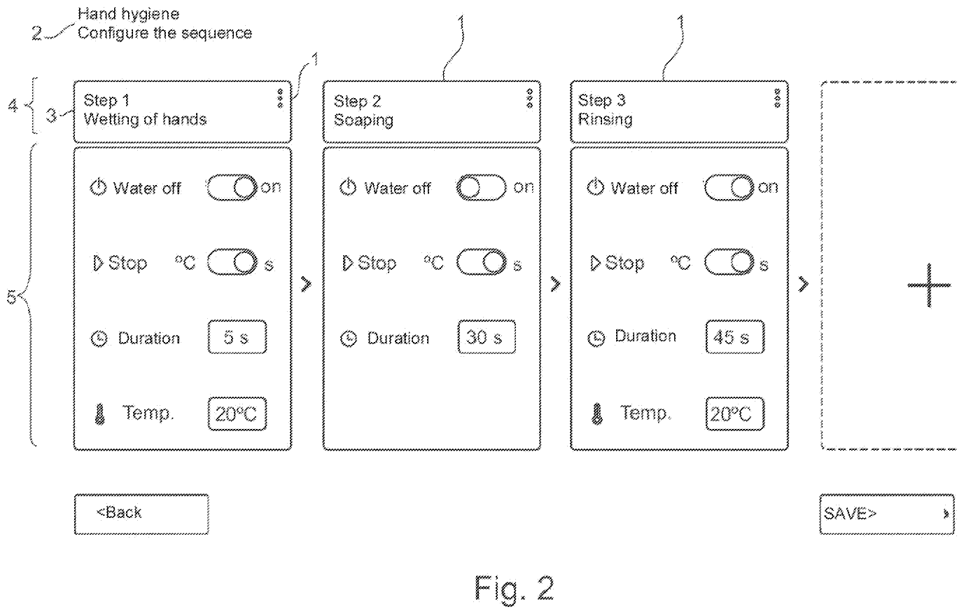

FIG. 2 shows a hand hygiene scene

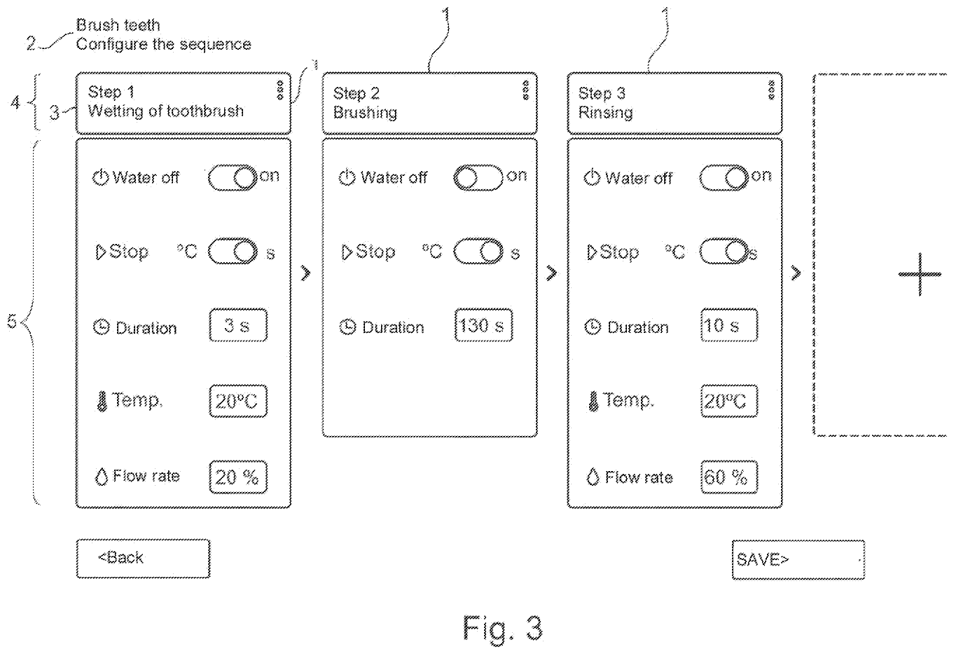

FIG. 3 shows a tooth brushing scene

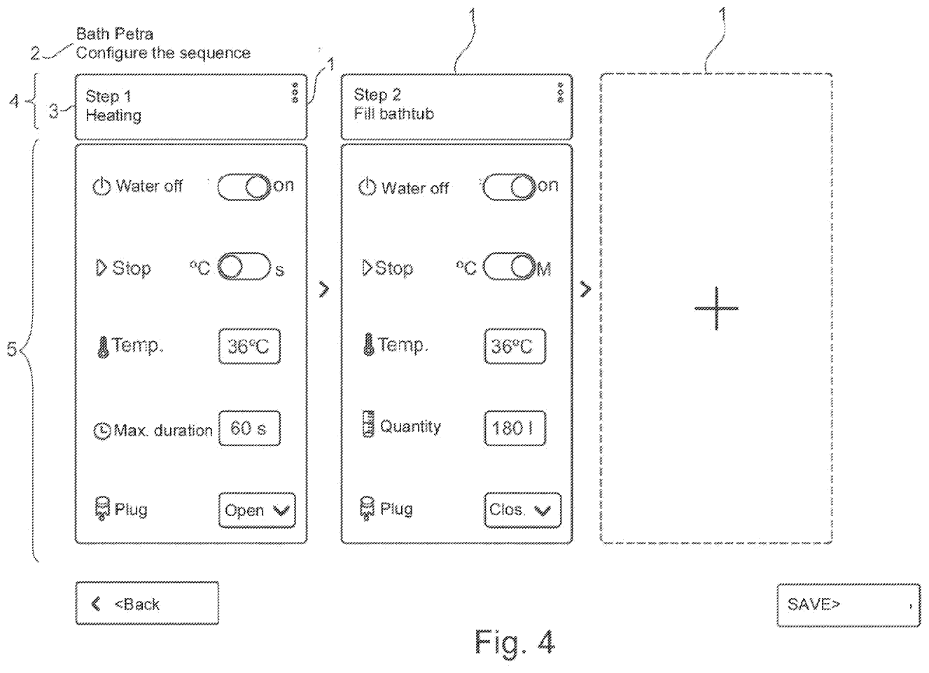

FIG. 4 shows a bath Petra scene

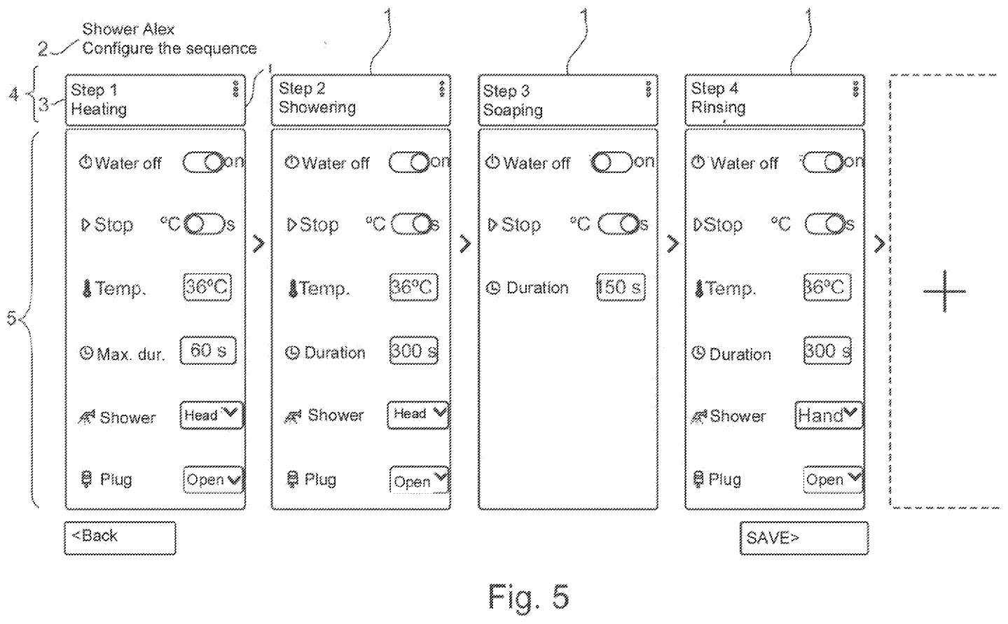

FIG. 5 shows a shower Alex scene

FIG. 1 shows a modular programming interface according to the invention with a neutral scene whose sequence program is not yet titled and whose module box 1 represents a template for step-by-step definition of a sequence at an extraction point. Instead of the scene title 2, the title of a concrete sequence program can be inserted, under which a sequence program can be stored. A module box 1 comprises a header part 4, in which a title 3 of the respective sequence step is entered for the respective (sequence) step. In addition, a module box 1 comprises a parameter field 5, in which the parameters for defining and controlling the respective sequence step are selected and specified. Depending on the type of scene, a corresponding number of parameters are defined in the parameter field 5, which can be of varying detail. The parameter field 5 of FIG. 1 shows the four main parameters for the sequence at a water extraction point, namely:
Water off or on (off/on) (with virtual switch controlling a corresponding valve via a control unit, adjustable for each sequence step);
Stop criterion for the respective sequence step (here either reaching of a temperature [° C.] or a time duration [s], selectable with virtual switch);
A defined time duration for the respective step [s];
A temperature for the escaping water [° C.].

The parameters can be symbolized by corresponding pictograms or icons, as shown on the left in parameter field 5. In the example of parameter field 5 of FIG. 1, the parameter settings shown mean that in the first sequence step the water should flow, i.e. be switched on, for a period of 3 seconds, and then the valve should close. The outflowing water should have a temperature of 20° C., i.e. in the inlet with corresponding peripheral devices or mixing valves are controlled or mixed to this setpoint temperature. To define a second sequence step, a next box can be added by clicking on the dashed module box 1 with the plus sign and parameterized in the same way.

In FIG. 2, the template from FIG. 1 was used to illustrate a simple hand hygiene sequence. This sequence program with the scene title 2 “Hand hygiene” comprises three steps with three successive module boxes 1. In the header part 4 of the module boxes 1, the respective sequence steps have been given the titles 3 “Wetting hands”, “Soaping up” and “Rinsing off”, which are both information and request to the user. After the start of this sequence program, water with a temperature of 20° C. flows for 5 seconds. The user can wet his hands during this time. In the following second step, a 30-second pause is defined in which the water is turned off and the user can soap his hands. In the second module box 1, there is no need to specify a temperature, because no water comes out. In the third and last step of the sequence program of FIG. 2, the water switches on again for 45 seconds at a water temperature of 20° C. This time is available for the user to rinse his hands. This sequence program then ends and the water is turned off by the sequence controller.

FIG. 2 shows the simple way in which a sequence can be configured with the modular programming interface of the sequence controller according to the invention. As many module boxes 1 can be created, defined with parameters and lined up in a clear manner as are necessary to represent the desired sequence. The editing of stored sequence programs, e.g. the adjustment of individual parameters, is carried out in exactly the same elegant way. On the other hand, pause times and time limits for water withdrawal can be used to reduce water consumption without anyone having to touch a tap.

FIG. 3 shows a sequence program analogous to FIG. 2 with the scene title 2 “Brushing teeth”. Here, it is defined in three module boxes 1 according to the sequence step titles 3 that the toothbrush (provided with toothpaste) is to be wetted first. For this purpose, water at a temperature of 20° C. is available at a water tap for 3 seconds. Because a greatly reduced outflow quantity is sufficient for this, an additional flow parameter can be specified in parameter field 5 as 20% of the maximum possible flow according to the example shown. The second flow step is intended as a 130 second pause time (without water) for “brushing” (title 3 of the second step) the teeth. In this second module box 1, neither a temperature nor a flow rate needs to be specified, since no water flows out. Finally, in the third module box 1 with the sequence step title 3 “Rinsing” in header part 4, it is specified in parameter field 5 that water with a temperature of 20° C. and a flow rate of 60% should flow during 10 seconds. During this time interval, the user can rinse the mouth and rinse the toothbrush. The flow rate is controlled or regulated accordingly by means of a flow sensor and a flow control valve in the supply line which can be controlled via a control member, both of which are connected to the control unit.

As can be seen from the description and the claims, the subject matter of the invention relates to a sequence controller which, according to the invention, offers the possibility of configuring sequences in a simple manner by means of a modular programming interface with module boxes 1 for individual sequence steps, as explained by way of example with reference to FIGS. 2 and 3. Two further examples are shown in FIGS. 4 and 5.

FIG. 4 is an example of how the stop criterion for a sequence step does not always have to be a time duration. The sequence program in FIG. 4 has the scene title 2 “Bath Petra”. It relates to the automated preparation of a bathtub for a bath. In parameter field 5 of module box 1, additional parameters can be defined for this type of scene. The lowest parameter is applicable if the bathtub has a controllable electromechanical actuating device for operating the bathtub plug. According to title 3 of the first sequence step, the incoming water is first heated with the plug open until it reaches the stop criterion of a temperature of 36° C., or up to a maximum duration of 60 seconds if the 36° C. had not yet been reached by then. Then the second sequence step follows with the title 3 “Fill bathtub”. When switching to the second step, the plug is closed and water with controlled temperature of 36° C. runs in. The stop criterion for the second sequence step is the total amount of water that has entered the bathtub during the second step, 180 liters in the example shown. Then a valve in the water supply line closes and the bath is ready. As a continuation it would be conceivable that in a next step a pause time (as bath time) of e.g. 15 minutes is defined, and then the bath plug is automatically opened to drain the bath water.

FIG. 5 shows an example of a sequence program in a modern shower under the scene title 2 “Shower Alex”. This shower has both an overhead shower and a hand shower, both of which can be activated via the sequence controller, as well as an electromechanically adjustable drain plug. Based on the titles 3 of the individual sequence steps and the parameter settings shown, the sequence is self-explanatory according to the explanations of the previous figures. With regard to the shower head parameter, it can be said that in the drop-down menu for this parameter, not only can either “head” or “hand” be selected, but as a third option, “head and hand” can also be selected simultaneously if one wishes to shower all around.

At this point, it should be noted that any combinations of the features described and/or shown in the figures are within the scope of the present invention as long as the combinations are not inconsistent.

As can be seen from the description and the explanations of the figures, the present invention provides an advantageous and easy-to-use alternative solution for a sequence controller for extraction points. Its modular programming interface, in which the individual sequence steps can be conveniently defined and lined up as corresponding modules, enables a high degree of individual flexibility and easily configurable personalized sequences, even without detailed knowledge of the programming language.

### LIST OF REFERENCE NUMERALS

Identical reference numerals in the figures indicate corresponding features, even if not explicitly referred to in the description of the individual figures in each case.
1 Module box
2 Title of the sequence program (scene title)
3 Title of the respective sequence step
4 Header part of module box 1
5 Parameter field of module box 1

1: A programmable sequence controller for extraction points and peripheral devices associated therewith for controlling sequences having individual sequence steps with controlled and/or regulated dispending of liquid media, comprising a control unit for data processing and for storing and executing selectable sequence programs, comprising a display and a sequence program selection option and a control panel for inputs, as well as interfaces for sensors and interfaces for actuating control members which can be connected to the control unit, characterized in that, for configuring and editing the selectable sequence programs, the sequence controller has a modular programming interface with module boxes (1) for the individual sequence steps, into which settings and criteria for the respective extraction point and peripheral devices associated therewith, as well as desired properties of the liquid medium to be dispensed or breaks during dispensing, can be entered via the control panel into a corresponding module box (1) for each sequence step, and the sequence steps can be lined up in the form of the corresponding module boxes (1) to form a sequence program for the sequence.

2: The programmable sequence controller according to claim 1, characterized in that the extraction points are water extraction points.

3: The programmable sequence controller according to claim 1, characterized in that the sequence program selection option is represented by selectable buttons on the control panel, or is embodied by a rotatable selector switch with start function, or comprises an acoustic selection option.

4: The programmable sequence controller according to claim 1, characterized in that the display is designed to initially indicate titles (2) of selectable sequence programs visually and/or acoustically, and after the start of a selected sequence program to indicate the respective sequence step with corresponding title (3) visually and/or acoustically.

5: The programmable sequence controller according to claim 1, characterized in that the control panel for inputs and for configuring and editing the selectable sequence programs is a touch input screen.

6: The programmable sequence controller according to claim 1, characterized in that the sensors connectable to interfaces of the control unit are pressure sensors, temperature sensors or flow sensors in supply lines or proximity sensors.

7: The programmable sequence controller according to claim 1, characterized in that the control members connectable to interfaces of the control unit for actuation are control members of valves or switches of pumps in supply lines, or switches of peripheral devices.

8: The programmable sequence controller according to claim 7, characterized in that the valves are shut-off valves, control valves, flow control valves or mixing valves, wherein the mixing valves are preferably controllable to a set temperature of the liquid medium specified in a module box.

9: A method for configuring a programmable sequence controller according to claim 1, characterized in that, when configuring a sequence program in the modular programming interface, as many module boxes (1) are created in each case one after the other from a template, defined with parameters and lined up, as sequence steps subdivided in time or according to other criteria are required to represent a complete sequence.

10: The method according to claim 9, characterized in that the template for the individual module boxes (1) comprises a header part (4) and a parameter field (5), and a title (3) for the respective sequence step is entered into the header part (4) in the prepared individual module boxes (1), and the parameters necessary for defining and controlling the respective sequence step are selected and specified in the parameter field (5).

11. A method for controlling sequences or scenes wherein the programmable sequence controller controls the sequences or scenes with successive sequence steps at extraction points, preferably for water extraction points and related operations in their environment, comprising the step of employing the programmable sequence controller according to claim 1.

12: The method according to claim 11, characterized in that the sequences or scenes are selected from the group consisting of tooth brushing, showering, bathing, hand washing and hand hygiene procedures.
